(19) United States
(12) Patent Application Publication
(10) Pub. No.: US 2024/0099325 A1
(43) Pub. Date: Mar. 28, 2024

(54) METHOD FOR PREPARING A CHOCOLATE PRODUCT

(71) Applicants: CARMEL B.V., CA BREDA (NL); Cargill Incorporated, Wayzata, MN (US)

(72) Inventors: Ingrid Godelieve Liliane DE WITTE, Deurne (BE); Marc Frans Valentine TROCH, Antwerpen (BE)

(73) Assignee: Cargill, Incorporated, Wayzata, MN (US)

(21) Appl. No.: 18/255,127

(22) PCT Filed: Nov. 30, 2021
(86) PCT No.: PCT/EP2021/083661

§ 371 Date: May 31, 2023

(30) Foreign Application Priority Data
Dec. 1, 2020 (WO) PCT/EP2020/084155
Dec. 1, 2020 (WO) PCT/EP2020/084156

(51) Int. Cl. A23G 1/40; A23G 1/00; A23G 1/30

(52) U.S. Cl. CPC A23G 1/40; A23G 1/0026; A23G 1/0046; A23G 1/305

(57) ABSTRACT

The invention relates to a method for preparing a chocolate product, the process comprising: (a) providing a mixture, said mixture comprising: (i) one or more cocoa components; (ii) a non-reducing sugar; (iii) one or more reducing sugars; and (iv) water; and (b) mechanically agitating the mixture at a temperature at which the mixture is in a liquid state. The invention further relates to a chocolate product comprising: (I) one or more cocoa components; (II) a non-reducing sugar; (III) one or more reducing sugars; and (IV) water wherein said chocolate product comprises between 4 and 20 wt. % of water with respect to the weight of the chocolate product, preferably between 6 and 15 wt. % of water with respect to the weight of the chocolate product.

### FIELD OF THE INVENTION

The invention relates to a method for preparing a chocolate product. The invention further relates to chocolate products and uses thereof.

### BACKGROUND OF THE INVENTION

Methods for producing a chocolate product are known. Chocolate products produced in the conventional manner generally melt or become sticky at a temperature above 33° C. This is due to the circumstance that cocoa butter and other fats sometimes used with or in place of cocoa butter melt in the range of 30° C. to 35° C.

This property is disadvantageous under certain circumstances, for instance in hot climates or in food processing where the chocolate products may be exposed to relatively high temperatures or when the chocolate product is held in the hand for longer periods of time.

In view of these problems, numerous attempts have been made to produce chocolate products having an increased heat resistance, i.e. which can withstand higher temperatures without melting or becoming sticky.

An early attempt has been described in U.S. Pat. No. 2,244,569A, which teaches hydrogenation of the chocolate to increase the resistance against high temperatures. Hydrogenation is a chemical process in which an unsaturated bond is converted into a saturated bond by the addition of hydrogen gas.

GB 1,000,159 teaches to increase the melting point by generating a sugar skeleton which is more resistant to collapse when the temperature exceeds the melting temperature of the fats in the chocolate. A process is taught wherein a first mass of chocolate containing amorphous sugar is mixed in fairly equal proportions with a second conched mass obtained in the usual way in which all the sugar is present in crystallized form. It is described that the development of heat resistance consists in storing the chocolate, in hermetically sealed wrappers, in a dry room where the temperature is kept constant at 25° C., for 20 to 30 days.

U.S. Pat. No. 5,160,760 describes the formation of a heat-resistant chocolate by dispersing and mixing a water-in-oil emulsion and a chocolate base material, wherein an oil phase in which a hydrophilic substance is contained is mixed and emulsified with an emulsifying agent to form said water-in-oil emulsion. Storage for about 20 days is carried out to contemplate increase in heat-resistance on time.

US 2018/0317517 gives an extensive overview of further attempts to prepare heat resistant chocolate. This document particularly refers to problems associated with the preparation of compounded or enrobed products such as heat resistant chocolate coated wafers, biscuits and the like, and proposes a method wherein water or a sorbitol solution are sprayed onto chocolate or a compound mass. Depending on the overall thickness of the desired heat resistant chocolate more layers of alternate spraying water or a polyol solution with the chocolate or compound are needed.

### SUMMARY OF THE INVENTION

In view of the above, there is a need for a method enabling the preparation of a heat-resistant chocolate product in an efficient manner.

According to the invention, there is provided a process for preparing a chocolate product, the process comprising:
(a) providing a mixture, said mixture comprising:
   (i) one or more cocoa components;
   (ii) a non-reducing sugar;
   (iii) one or more reducing sugars; and
   (iv) water;
and
b) mechanically agitating the mixture at a temperature at which the mixture is in a liquid state and/or at a temperature of at least 40° C.

Preferably, the non-reducing sugar is sucrose.

Preferably, the one or more reducing sugars include glucose.

Preferably, providing the mixture comprises:
(I) preparing a pre-mixture, said pre-mixture comprising at least part of said one or more cocoa components, at least part of said sucrose, at least part of said one or more reducing sugars, and water; and
(II) heating the pre-mixture at a temperature of at least 90° C., preferably of at least 100° C., and/or heating said pre-mixture at a temperature sufficiently high to effect evaporation of at least part of the water in the pre-mixture;

Preferably, the method further comprises:
(c) aging the mixture resulting from step (b), preferably at a temperature below 40° C.

The invention further relates to a chocolate product obtained or obtainable by the method according to the invention.

Surprisingly, it was found that the method according the invention enables to obtain a heat resistant chocolate product with an excellent taste. It was found that, after cooling of the mixture to a temperature of preferably below 40° C., heat resistance develops. Without wishing to be bound by any scientific theory, this development of heat resistance is believed to be associated with the development of a structure of sugar and water which entraps the cocoa butter and/or chocolate compatible fat, thereby avoiding or limiting its release at elevated temperatures. The term heat resistant in the context of chocolate products is known in the art. As used herein this term preferably refers to a chocolate product which does not melt when stored in an oven at 40° C. for a period of 30 minutes. The skilled person will understand this to mean that the chocolate product keeps its original shape when stored in an oven at 40° C. for a period of 30 minutes.

The time within which the heat resistance develops may vary depending on the temperature and specific recipe and was generally found to be within a few minutes to several days. The presence of reducing sugar was found to extend the time during which processability of the mixture remains optimal, thereby enabling a longer period for mechanically agitating such that an optimal structure of the chocolate product may be achieved. Furthermore, the presence of a reducing sugar enables a longer period for forming and molding, thereby facilitating the application of the mixture on a desired product and/or the enrobing of products with the mixture. Additionally, the presence of reducing sugar was found to enhance the taste experience.

The taste and aromas of chocolate were found to be released in the mouth in a manner which is experienced by the user as forceful and very pleasant. Without wishing to be bound by any scientific theory, it is believed that the sugar and water structure breaks or is disintegrated in the mouth, thereby releasing the cocoa butter and/or chocolate compatible fat and other flavour components. Further, and without wishing to be bound by any scientific theory, it is believed that the strong and pleasant flavour experienced by the user is enhanced by compounds formed by Maillard reactions due to the presence of reducing sugar.

The invention further provides a chocolate product comprising:
(I) one or more cocoa components;
(II) a non-reducing sugar;
(III) one or more reducing sugars; and
(IV) water
   wherein said chocolate product comprises between 4 and 20 wt. % of water with respect to the weight of the chocolate product.

Preferably, the non-reducing sugar is sucrose.

Preferably, the one or more reducing sugars include glucose.

The invention further relates to a method for preparing a food product, said method comprising preparing a chocolate product using the method according to the invention and/or providing a chocolate product obtainable by the method according to the invention and/or providing a chocolate product according to the invention; and using the chocolate product to prepare the food product.

The invention further provides a food product comprising a chocolate product according to the invention.

The invention further provides the use of a chocolate product according to the invention for the preparation of a food product.

### DETAILED DESCRIPTION OF THE INVENTION

### Chocolate Product

The invention provides chocolate products and methods for preparing a chocolate product. Whilst it is understood that the term chocolate may have legal definitions with respect to various amounts of various cocoa components, such as cocoa butter, cocoa solids, sugar, and whilst the method according to the invention enables to obtain products meeting such legal requirements, the method according to the invention is not limited to preparing such products. As used herein the term chocolate product refers to the product having the characteristics defined herein. In the method claims, the term chocolate product encompasses a product obtained or obtainable by the method as defined.

### (a) Providing the Mixture

The method according to the invention comprises providing a mixture, said mixture comprising:
(i) one or more cocoa components;
(ii) a non-reducing sugar;
(iii) one or more reducing sugars; and
(iv) water

Preferably, the mixture provided in (a) has the preferred characteristics disclosed hereinbelow.

As used herein cocoa components refer to components derived from cocoa beans, such as for instance cocoa butter and cocoa solids.

Preferably, the cocoa components in the mixture include cocoa butter. In another preferred embodiment, the cocoa components in the mixture include cocoa butter and cocoa solids.

In another embodiment of the invention, the mixture comprises a chocolate compatible fat and one or more cocoa components. As used herein, the term the chocolate compatible fat encompasses any of the vegetable or other fats suitable for use in combination with or in place of cocoa butter. A chocolate compatible fat can also be referred to as cocoa butter equivalent, cocoa butter replacer, cocoa butter alternative, or cocoa butter substitute. Exemplary chocolate compatible fats include for instance palm oil, in particular fractionated palm oil, palm kernel oil, illipe and shea nut butter, (fractionated and/or partially hydrogenated) soybean cotton or cottonseed oil, (fractionated and/or partially hydrogenated), coconut oil, lauric fat compounds. Said one or more other cocoa components preferably include cocoa butter and/or cocoa solids.

Cocoa components may be provided in any suitable manner, for instance by admixing cocoa butter, cocoa powder, cocoa mass (when in the liquid state also referred to as cocoa liquor), conched chocolate and/or any combination thereof to obtain the mixture.

Optimal results are obtained by providing at least part of the cocoa components by admixing cocoa liquor, cocoa mass and/or conched chocolate to obtain the mixture. As is understood by the skilled person, conched chocolate refers to the product obtained by a conching process.

Cocoa butter may be provided by admixing cocoa butter as such. It is also possible to provide cocoa butter by admixing cocoa butter-containing products, such as cocoa liquor, cocoa mass, and/or conched chocolate to obtain the mixture.

The cocoa components may be present in the mixture at any suitable concentration. Preferably, the mixture comprises at least 5 wt. %, preferably at least 10 wt. %, more preferably at least 20 wt. % of cocoa components with respect to the weight of the mixture, excluding water. There is no particular upper limit for the concentration of cocoa components in the mixture. Generally, the mixture comprises less than 60 wt. % of cocoa components with respect to the weight of the mixture, excluding water, for instance less than 50 wt. %, for instance less than 40 wt. % of cocoa components with respect to the weight of the mixture, excluding water. Preferably, the mixture comprises between 5 and 60 wt. %, preferably between 10 and 50 wt. %, more preferably between 20 and 40 wt. % of cocoa components with respect to the weight of the mixture, excluding water. Most preferably, the mixture comprises at least 32 wt. % of cocoa components, or at least 35 wt. % of cocoa components with respect to the weight of the mixture, excluding water, such as between 32 and 40 wt. % of cocoa components or between 35 and 40 wt. % of cocoa components with respect to the weight of the mixture, excluding water.

In an embodiment of the invention the mixture does not comprise cocoa components originating from processed chocolate, e.g. conched chocolate.

The cocoa butter may be present in the mixture at any suitable concentration. Preferably, the mixture comprises at least 5 wt. %, more preferably at least 10 wt. %, more preferably at least 15 wt. % of cocoa butter with respect to the weight of the mixture, excluding water. There is no particular upper limit for the concentration of cocoa butter in the mixture. Generally, the mixture comprises less than 40 wt. % of cocoa butter with respect to the weight of the mixture excluding water, for instance less than 35 wt. %, for instance less than 30 wt. % of cocoa butter with respect to the weight of the mixture, excluding water. Preferably, the mixture comprises between 5 and 40 wt. % of cocoa butter, preferably between 10 and 35 wt. % of cocoa butter, more preferably between 15 and 30 wt. % of cocoa butter with respect to the weight of the mixture, excluding water.

The mixture comprises a non-reducing sugar. Preferably, the non-reducing sugar is a disaccharide. Preferably, the non-reducing sugar is selected from the group consisting of sucrose, trehalose and combinations thereof. Most preferably, the non-reducing sugar is sucrose. As is well known to the skilled person, sucrose is a disaccharide, a molecule composed of two monosaccharides: glucose and fructose.

The mixture comprises one or more reducing sugars. As is well known to the skilled person, a reducing sugar is any sugar that is capable of acting as a reducing agent, because it has a free aldehyde group or a free ketone group. The one or more reducing sugars may for instance be selected from the group consisting of monosaccharides (e.g. glucose, fructose, allulose, or xylose), disaccharides (e.g. maltose, lactose, or cellobiose), DP3 saccharides (e.g. maltotriose) and DP4 saccharides (e.g. maltotetralose) and combinations thereof.

Preferably, the one or more reducing sugars include one or more monosaccharides. The one or more monosaccharides are preferably selected from the group consisting of glucose, fructose, allulose, xylose and combinations thereof.

The non-reducing sugar may be present in the mixture at any suitable concentration. Preferably, the mixture comprises at least 25 wt. % of non-reducing sugar with respect to the weight of the mixture, excluding water, preferably at least 35 wt. %, more preferably at least 40 wt. % non-reducing sugar with respect to the weight of the mixture, excluding water. There is no particular upper limit for the concentration of non-reducing sugar in the mixture. Generally, the mixture comprises less than 70 wt. % of non-reducing sugar with respect to the weight of the mixture excluding water, for instance less than 65 wt. %, for instance less than 60 wt. % with respect to the weight of the mixture, excluding water. Preferably, the mixture comprises between 25 and 70 wt. % of non-reducing sugar, preferably between 35 and 65 wt. %, more preferably between 40 and 60 wt. % of non-reducing sugar with respect to the weight of the mixture, excluding water. As used herein, As used herein, the wt. % of non-reducing sugar refers to the sum weight of the non-reducing sugars present in the mixture.

Sucrose may be present in the mixture at any suitable concentration. Preferably, the mixture comprises at least 25 wt. % of sucrose with respect to the weight of the mixture, excluding water, preferably at least 35 wt. %, more preferably at least 40 wt. % sucrose with respect to the weight of the mixture, excluding water. There is no particular upper limit for the concentration of sucrose in the mixture. Generally, the mixture comprises less than 70 wt. % of sucrose with respect to the weight of the mixture excluding water, for instance less than 65 wt. %, for instance less than 60 wt. % with respect to the weight of the mixture, excluding water. Preferably, the mixture comprises between 25 and 70 wt. % of sucrose, preferably between 35 and 65 wt. %, more preferably between 40 and 60 wt. % of sucrose with respect to the weight of the mixture, excluding water.

The mixture comprises one or more reducing sugars. The presence of a reducing sugar has been found to extend the time during which processability of the mixture remains optimal after cooling. Without wishing to be bound by any scientific theory this effect is believed to be associated with the interaction of the reducing sugar with the crystallization of sucrose. Furthermore, the presence of a reducing sugar is believed to enhance the taste experience. Without wishing to be bound by any scientific theory, this effect is believed to be associated with the occurrence of Maillard reactions between the reducing sugar and amino acids from originating from the cocoa components, when the mixture is exposed to temperature during heating. The one or more reducing sugars may include at least partly inverted sugar syrup, which may for instance be obtained through acid hydrolysis of an aqueous solution of sucrose. Preferably, the one or more reducing sugars include one or more monosaccharides, for instance one or more monosaccharides selected from the group consisting of glucose and fructose. More preferably, the one or more reducing sugars include or consist of glucose.

The non-reducing sugar and one or more reducing sugars can be applied at any suitable ratio. Preferably, the ratio of the non-reducing sugar to the one or more reducing sugars in the mixture is between 95:5 and 50:50, preferably between 90:10 and 60:40, on a weight basis. Thus, as used herein, the weight of the one or more reducing sugars refers to the sum weight of the reducing sugars. As used herein the weight of the non-reducing sugar refers to the sum weight of the non-reducing sugars in the mixture. In an embodiment of the invention, the ratio of the non-reducing sugar to said one or more reducing sugars is equal to or below 67:33, preferably between 95:5 and 67:33, more preferably between 95:10 and 70:30, on a weight basis.

In a preferred embodiment, the one or more reducing sugars include one or more monosaccharides. Preferably, the ratio of the non-reducing sugar to said one or more monosaccharides in the mixture is between 95:5 and 50:50, preferably between 90:10 and 60:40, on a weight basis. Thus, as used herein, the weight of the one or more reducing sugars refers to the sum weight of the one or more monosaccharides. In an embodiment of the invention, the ratio of the non-reducing sugar to said one or more monosaccharides is equal to or below 67:33, preferably between 95:5 and 67:33, more preferably between 95:10 and 70:30, on a weight basis.

In a preferred embodiment, the one or more reducing sugars include glucose. Preferably, the ratio of the non-reducing sugar to glucose in the mixture is between 95:5 and 50:50, preferably between 90:10 and 60:40, on a weight basis. In an embodiment of the invention, the ratio of the non-reducing sugar to glucose is equal to or below 67:33, preferably between 95:5 and 67:33, more preferably between 95:10 and 70:30, on a weight basis.

Preferably, the non-reducing sugar is sucrose.

The sucrose and one or more reducing sugars can be applied at any suitable ratio. Preferably, the ratio of sucrose to one or more reducing sugars in the mixture is between 95:5 and 50:50, more preferably between 90:10 and 60:40, on a weight basis. Thus, as used herein, the weight of the one or more reducing sugars refers to the sum weight of the reducing sugars. In an embodiment of the invention, the ratio of sucrose to said one or more reducing sugars is equal to or below 67:33, preferably between 95:5 and 67:33, more preferably between 95:10 and 70:30, on a weight basis.

Preferably, the ratio of sucrose to one or more monosaccharides in the mixture is between 95:5 and 50:50, more preferably between 90:10 and 60:40, on a weight basis. Thus, as used herein the weight of the one or more monosaccharides refers to the sum weight of the monosaccharides. In an embodiment of the invention, the ratio of sucrose to said one or more monosaccharides is equal to or below 67:33, preferably between 95:5 and 67:33, more preferably between 95:10 and 70:30, on a weight basis.

Preferably, the ratio of sucrose to glucose in the mixture is between 95:5 and 50:50, more preferably between 90:10 and 60:40, on a weight basis. In an embodiment of the invention, the ratio of sucrose to glucose is equal to or below 67:33, preferably between 95:5 and 67:33, more preferably between 95:10 and 70:30, on a weight basis.

The mixture comprises water. The amount of water in the mixture may vary between wide ranges. The concentration of water in the mixture may for instance be at least 4 wt. % with respect of the weight of the mixture, preferably at least 5 wt. %, more preferably at least 6 wt. %, even more preferably above 7 wt. %, most preferably at least 7.5 wt. % with respect to the weight of the mixture. The use of increased concentrations of water was found to improve the texture of the chocolate product in that graininess and/or dryness are limited. Preferably, the concentration of water in the mixture is less than 25 wt. %, with respect to the weight of the mixture, more preferably less than 20 wt. %, more preferably less than 18 wt. %, most preferably less than 15 wt. % with respect to the weight of the mixture. If the concentration of water is too high it becomes more difficult to obtain a solid structure. Without wishing to be bound by any scientific theory, it is believed that the water content in the mixture is advantageously sufficiently low to enable sufficient saturation that solidification and/or crystallization of sugars can occur upon cooling.

The skilled person will realize that the water may be provided by admixing water into the mixture as such, or as part of any suitable water containing composition, such as for instance milk or a water containing syrup, for instance glycose syrup.

Optionally, the mixture comprises milk components, for instance milk powder. The concentration of milk components in the mixture may for instance be between 10 and 30 wt. % with respect to the weight of the mixture, excluding water.

The mixture may comprise further components. For instance, the mixture may comprise a sucrose ester. However, this is not necessary. Preferably, the mixture does not comprise any sucrose ester.

The mixture may further comprise flavour and/or color components, for instance vanilla aroma, mint aroma, hazelnut aroma, orange aroma. The mixture may also comprise other components, e.g. nuts or caramel.

In a preferred embodiment the fats in the mixture are solid at 20° C.

The mixture may be provided in any suitable manner. In a preferred embodiment, providing the mixture comprises:
(I) preparing a pre-mixture, said pre-mixture comprising at least part of said one or more cocoa components, at least part of said non-reducing sugar (preferably sucrose), at least part of said one or more reducing sugars, and water; and
(II) heating the pre-mixture at a temperature of at least 90° C., preferably of at least 100° C., and/or heating said pre-mixture at a temperature sufficiently high to effect evaporation of at least part of the water in the pre-mixture.
   This preferred embodiment enables to obtain the mixture in a very efficient manner.

In a preferred embodiment, the method further comprises:
(III) cooling the mixture resulting from (II).
   Cooling enables the temperature at which the mixture is mechanically agitated in step (b) to be reached.

The pre-mixture comprises at least part of the one or more cocoa components, at least part of said non-reducing sugar (preferably sucrose), at least part of said one or more reducing sugars, and water. In an embodiment of the invention, the pre-mixture comprises the entirety of the cocoa components, the non-reducing sugar (preferably sucrose) and the one or more reducing sugars to be present in the mixture. In a further embodiment, the pre-mixture comprises the entirety of the non-reducing sugar (preferably sucrose) and the one or more reducing sugars to be present in the mixture.

In a preferred embodiment, the method comprises, after (II) or after (III), adding part of the cocoa components to the pre-mixture. For instance, the method may comprise, after (II) or (III), adding part of the cocoa mass and/or cocoa butter to the pre-mixture. It is also possible to add, after (II) or after (III), part of the one or more reducing sugars to the pre-mixture.

The one or more cocoa components, non-reducing sugar (preferably sucrose), one or more reducing sugars and water may be present in the pre-mixture in any amount enabling to obtain the mixture.

The cocoa components may be present in the pre-mixture at any suitable concentration. Preferably, the pre-mixture comprises at least 5 wt. %, preferably at least 10 wt. %, more preferably at least 20 wt. % of cocoa components with respect to the weight of the pre-mixture, excluding water. There is no particular upper limit for the concentration of cocoa components in the pre-mixture. Generally, the pre-mixture comprises less than 60 wt. % of cocoa components with respect to the weight of the pre-mixture, excluding water, for instance less than 50 wt. %, for instance less than 40 wt. % of cocoa components with respect to the weight of the pre-mixture, excluding water. Preferably, the pre-mixture comprises between 5 and 60 wt. %, preferably between 10 and 50 wt. %, more preferably between 20 and 40 wt. % of cocoa components with respect to the weight of the pre-mixture, excluding water. Most preferably, the pre-mixture comprises at least 32 wt. % of cocoa components, or at least 35 wt. % of cocoa components with respect to the weight of the pre-mixture, excluding water, such as between 32 and 40 wt. % of cocoa components or between 35 and 40 wt. % of cocoa components with respect to the weight of the pre-mixture, excluding water.

The cocoa butter may be present in the pre-mixture at any suitable concentration. Preferably, the pre-mixture comprises at least 5 wt. %, more preferably at least 10 wt. %, more preferably at least 15 wt. % of cocoa butter with respect to the weight of the pre-mixture, excluding water. There is no particular upper limit for the concentration of cocoa butter in the pre-mixture. Generally, the pre-mixture comprises less than 40 wt. % of cocoa butter with respect to the weight of the pre-mixture excluding water, for instance less than 35 wt. %, for instance less than 30 wt. % of cocoa butter with respect to the weight of the pre-mixture, excluding water. Preferably, the pre-mixture comprises between 5 and 40 wt. % of cocoa butter, preferably between 10 and 35 wt. % of cocoa butter, more preferably between 15 and 30 wt. % of cocoa butter with respect to the weight of the pre-mixture, excluding water.

The non-reducing sugar may be present in the pre-mixture at any suitable concentration. Preferably, the pre-mixture comprises at least 25 wt. % of non-reducing sugar with respect to the weight of the pre-mixture, excluding water, preferably at least 35 wt. %, more preferably at least 40 wt. % non-reducing sugar with respect to the weight of the pre-mixture, excluding water. There is no particular upper limit for the concentration of non-reducing sugar in the pre-mixture. Generally, the pre-mixture comprises less than 70 wt. % of non-reducing sugar with respect to the weight of the pre-mixture excluding water, for instance less than 65 wt. %, for instance less than 60 wt. % with respect to the weight of the pre-mixture, excluding water. Preferably, the pre-mixture comprises between 25 and 70 wt. % of non-reducing sugar, preferably between 35 and 65 wt. %, more preferably between 40 and 60 wt. % of non-reducing sugar with respect to the weight of the pre-mixture, excluding water. As used herein, As used herein, the wt. % of non-reducing sugar refers to the sum weight of the non-reducing sugars present in the pre-mixture.

Sucrose may be present in the pre-mixture at any suitable concentration. Preferably, the pre-mixture comprises at least 25 wt. % of sucrose with respect to the weight of the pre-mixture, excluding water, preferably at least 35 wt. %, more preferably at least 40 wt. % sucrose with respect to the weight of the pre-mixture, excluding water. There is no particular upper limit for the concentration of sucrose in the pre-mixture. Generally, the pre-mixture comprises less than 70 wt. % of sucrose with respect to the weight of the pre-mixture excluding water, for instance less than 65 wt. %, for instance less than 60 wt. % with respect to the weight of the pre-mixture, excluding water. Preferably, the pre-mixture comprises between 25 and 70 wt. % of sucrose, preferably between 35 and 65 wt. %, more preferably between 40 and 60 wt. % of sucrose with respect to the weight of the pre-mixture, excluding water.

The pre-mixture comprises one or more reducing sugars. The presence of a reducing sugar has been found to extend the time during which processability of the pre-mixture remains optimal after cooling. Without wishing to be bound by any scientific theory this effect is believed to be associated with the interaction of the reducing sugar with the crystallization of sucrose. Furthermore, the presence of a reducing sugar is believed to enhance the taste experience. Without wishing to be bound by any scientific theory, this effect is believed to be associated with the occurrence of Maillard reactions between the reducing sugar and amino acids from originating from the cocoa components, when the pre-mixture is exposed to temperature during heating. The one or more reducing sugars may include at least partly inverted sugar syrup, which may for instance be obtained through acid hydrolysis of an aqueous solution of sucrose. Preferably, the one or more reducing sugars include one or more monosaccharides, for instance one or more monosaccharides selected from the group consisting of glucose and fructose. More preferably, the one or more reducing sugars include glucose.

The non-reducing sugar and one or more reducing sugars can be applied at any suitable ratio. Preferably, the ratio of the non-reducing sugar to the one or more reducing sugars in the pre-mixture is between 95:5 and 50:50, preferably between 90:10 and 60:40, on a weight basis. Thus, as used herein, the weight of the one or more reducing sugars refers to the sum weight of the reducing sugars. As used herein the weight of the non-reducing sugar refers to the sum weight of the non-reducing sugars in the pre-mixture. In an embodiment of the invention, the ratio of the non-reducing sugar to said one or more reducing sugars is equal to or below 67:33, preferably between 95:5 and 67:33, more preferably between 95:10 and 70:30, on a weight basis.

In a preferred embodiment, the one or more reducing sugars include one or more monosaccharides. Preferably, the ratio of the non-reducing sugar to said one or more monosaccharides in the pre-mixture is between 95:5 and 50:50, preferably between 90:10 and 60:40, on a weight basis. Thus, as used herein, the weight of the one or more reducing sugars refers to the sum weight of the one or more monosaccharides. In an embodiment of the invention, the ratio of the non-reducing sugar to said one or more monosaccharides is equal to or below 67:33, preferably between 95:5 and 67:33, more preferably between 95:10 and 70:30, on a weight basis.

In a preferred embodiment, the one or more reducing sugars include glucose. Preferably, the ratio of the non-reducing sugar to glucose in the pre-mixture is between 95:5 and 50:50, preferably between 90:10 and 60:40, on a weight basis. In an embodiment of the invention, the ratio of the non-reducing sugar to glucose is equal to or below 67:33, preferably between 95:5 and 67:33, more preferably between 95:10 and 70:30, on a weight basis.

Preferably, the non-reducing sugar is sucrose.

The sucrose and one or more reducing sugars can be applied at any suitable ratio. Preferably, the ratio of sucrose to one or more reducing sugars in the pre-mixture is between 95:5 and 50:50, more preferably between 90:10 and 60:40, on a weight basis. Thus, as used herein, the weight of the one or more reducing sugars refers to the sum weight of the reducing sugars. In an embodiment of the invention, the ratio of sucrose to said one or more reducing sugars is equal to or below 67:33, preferably between 95:5 and 67:33, more preferably between 95:10 and 70:30, on a weight basis.

Preferably, the ratio of sucrose to one or more monosaccharides in the pre-mixture is between 95:5 and 50:50, more preferably between 90:10 and 60:40, on a weight basis. Thus, as used herein the weight of the one or more monosaccharides refers to the sum weight of the monosaccharides. In an embodiment of the invention, the ratio of sucrose to said one or more monosaccharides is equal to or below 67:33, preferably between 95:5 and 67:33, more preferably between 95:10 and 70:30, on a weight basis.

Preferably, the ratio of sucrose to glucose in the pre-mixture is between 95:5 and 50:50, more preferably between 90:10 and 60:40, on a weight basis. In an embodiment of the invention, the ratio of sucrose to glucose is equal to or below 67:33, preferably between 95:5 and 67:33, more preferably between 95:10 and 70:30, on a weight basis.

The pre-mixture comprises water. The amount of water in the pre-mixture may vary between wide ranges. Any suitable water content may be applied in the pre-mixture which enables to obtain the mixture. Based on the teaching provided herein, the skilled person is able to determine such amounts. Preferably, a pre-mixture is provided having a water content sufficient such that all sucrose and all reducing sugars may be dissolved. There is no specific upper limit for the water content of the pre-mixture which is provided. If a very high water content is applied, relatively large amounts of water need to be evaporated which is disadvantageous from an economic point of view.

In a preferred embodiment, a pre-mixture is provided having a water content of for instance be at least 5 wt. %, more preferably at least 7 wt. %, most preferably at least 10 wt. % with respect to the weight of the mixture. Preferably, a pre-mixture is provided having a water content of less than 50 wt. %, with respect to the weight of the mixture, more preferably less than 40 wt. %.

The skilled person will realize that the water may be provided by admixing water into the pre-mixture as such, or as part of any suitable water containing composition, such as for instance milk or a water containing syrup, for instance glycose syrup.

The skilled person will understand that the preparation of the pre-mixture is not limited to any sequence of admixing of ingredients. For instance, it is possible to mix the ingredients at once. In a preferred embodiment the method comprises mixing and heating water and/or milk, sucrose and the reducing sugar first, for instance to a temperature above 65° C., preferably above 80° C., and followed by adding the cocoa components and the optional chocolate compatible fat.

Heating may be carried out in any suitable manner to effect evaporation of at least part of the water. Evaporation of at least part of the water was found to be an efficient way of obtaining the water content of the mixture which is agitated in (b).

It is possible to perform the heating at reduced pressure, such that evaporation occurs at a lower temperature. Preferably, heating is carried out at a temperature of at least 90° C., preferably of at least 100° C. This was found to result in a chocolate product having an excellent flavour. It is hypothesized that this may be due to Maillard reactions occurring at elevated temperature between amino acids present in the cocoa components and reducing sugar. Preferably, the sugar and glucose are in the dissolved state during said heating.

Heating the pre-mixture in (II) may be effected for any suitable time. It is observed that an increased heating time improves the flavour of the end product. Heating the pre-mixture at the temperature disclosed may for instance be effected for a period of at least 1 minute, for instance between 1 and 10 minutes.

Heating may be effected in any suitable vessel known for this purpose. An open vessel is advantageously used. Alternatively, and vessel with an outlet permitting the release of evaporated water may advantageously be used.

Preferably, the method according to the invention comprises agitating the mixture during at least part of the heating, for instance by stirring. Mechanically agitating, such as by stirring enables to keep the mixture homogeneous.

Cooling in (III) may be effected in any suitable manner. Cooling may for instance be effected in a vessel. Cooling may also be effected by contacting the mixture with a cooling surface, for instance a cooling table or a worktop, for instance a marble worktop. A cooling tunnel may also be used.

### b) Mechanically Agitating the Mixture

The method according to the invention comprises mechanically agitating the mixture. Mechanically agitating may be effected at a temperature at which the mixture is in a liquid state. Mechanically agitating enables to obtain a homogeneous mixture in an efficient manner.

Mechanically agitating may be effected in any suitable manner, for instance by stirring and/or kneading.

Preferably, mechanically agitating is effected at a temperature of at least 40° C., for instance between 40 and 85° C. In a preferred embodiment, mechanically agitating is effected at a temperature between 45 and 80° C., more preferably between 50 and 75° C.

Preferably, mechanically agitating is effected for at least 0.5 minutes, more preferably for at least 1 minute, most preferably at least 2 minutes. There is no particular upper limit for the time during which mechanically agitating is effected. Mechanically agitating may for instance be effected for less than 10 minutes. The most preferred period during which mechanically agitating may be effected is dependent on the exact recipe. In an embodiment of the invention, mechanically agitating is effected for a period of between 4 and 6 minutes.

Following, the step of mechanically agitating, the mixture may be cooled in any suitable manner.

It is well known that cocoa butter can crystallize into different forms referred to as forms I to VI and that form V is preferred, as this results in a texture which is appreciated by the consumers. Form V is preferentially formed at a temperature of around 34° C. Reference is for instance made to Stephen Beckett, The Science of Chocolate, RSC Publishing 200, p. 107-116. Preferably, the process according to the invention is carried out such as to induce formation of type V crystals. This may for instance be achieved by treating the mixture at a temperature suitable for forming type V crystals.

### (c) Aging

It was found that, after step (b) heat resistance naturally develops. Accordingly, the method preferably comprises aging the mixture resulting from step (b) to obtain a heat resistant chocolate product. Aging may be effected at any suitable manner and refers, as used herein, to storing or keeping the mixture under conditions whereby heat resistance develops, preferably as defined below.

Preferably the heat resistant chocolate product does not melt when kept in an oven at 40° C. for a period of 30 minutes, more preferably the heat resistant product does not melt when kept in an oven at 50° C., more preferably at 60° C., more preferably at 70° C. for a period of 30 minutes.

Aging is found to happen naturally at a temperature below 40° C., preferably below 35° C., more preferably below 30° C. such as room temperature. Accordingly, the method according to the invention preferably comprises:

(c) subjecting the mixture resulting from step (b) to aging wherein the temperature of the mixture is below 40° C., preferably below 35° C., more preferably below 30° C. for a period of at least 30 minutes; and/or wherein the mixture resulting from step (b) is kept at a temperature sufficiently low and a period sufficiently long such that a heat resistant chocolate product is obtained.

In an exemplary embodiment of the invention aging is effected at a temperature between 1 and 10° C., for instance in a refrigerating apparatus or a cool or cooling chamber.

It was found that the chocolate product resulting from the aging stage can comprise a continuous sugar network. Without wishing to be bound by any scientific theory it is believed that the development of heat resistance is associated with the development of such sugar network. The presence of a sugar network in heat resistant products has been described in Stortz, Terri & Marangoni, Alejandro. (2011). Heat resistant chocolate. Trends in Food Science & Technology—TRENDS FOOD SCI TECHNOL. 22. 201-214. 10.1016/j.tifs.2011.02.001. The presence of a sugar network can be detected by autofluorescence measurement using a confocal laser scanning microscope and using excitation by a UV range laser (405 nm) and detection of emitted signals between 415-500 nm. A description of autofluorescence measurement of sugar is provided in Baunsgaard, Dorrit & Munck, L. & Norgaard, Lars. (2000). Analysis of the Effect of Crystal Size and Color Distribution on Fluorescence Measurements of Solid Sugar Using Chemometrics. Applied Spectroscopy—APPL SPECTROSC. 54. 1684-1689. 10.1366/0003702001948727.

Accordingly, preferably, the method comprises aging the mixture resulting from step (b) to obtain a chocolate product comprising a sugar network.

In practice, aging does not require a specific treatment. It can be effected by storage of the product and/or in the packaging.

### Further Embodiments

In a further embodiment the method of the invention does not include a refining step and/or conching step.

### Storing and Transporting

It was found that a chocolate product obtained or obtainable by step (a), preferably obtained or obtainable by steps (I), (II) and, optionally, (III), may be effectively stored and/or transported, and still be used to obtain a heat resistant product. Accordingly, the invention further relates to a method for preparing and storing or transporting a chocolate product, the process comprising storing the mixture obtained in step (a) at a temperature between 50 and 90° C., preferably to a temperature between 60 and 85° C., more preferably to a temperature between 65 and 80° C.

The invention also relates to a chocolate product obtainable by this process.

### Chocolate Products

The invention further provides chocolate products. The chocolate products advantageously are heat resistant or are useful intermediates to obtain heat resistant chocolate products.

The invention provides a chocolate product obtainable by the methods according to the invention.

The invention further provides a chocolate product comprising:
(I) one or more cocoa components;
(II) a non-reducing sugar;
(III) one or more reducing sugars; and
(IV) water
   wherein said chocolate product comprises between 4 and 20 wt. % of water with respect to the weight of the chocolate product,

Preferably, the chocolate product comprises between 6 and 15 wt. % of water with respect to the weight of the chocolate product, more preferably between 7 and 12 wt. % of water with respect to the weight of the chocolate product, most preferably between 7.5 and 10 wt. % of water with respect to the weight of the chocolate product. It was found that the water contents within the preferred ranges contribute to the excellent taste and structure.

The chocolate product comprises a non-reducing sugar. Preferably, the non-reducing sugar is a disaccharide. Preferably, the non-reducing sugar is selected from the group consisting of sucrose, trehalose and combinations thereof. Most preferably, the non-reducing sugar is sucrose. As is well known to the skilled person, sucrose is a disaccharide, a molecule composed of two monosaccharides: glucose and fructose.

The chocolate product comprises one or more reducing sugars. As is well known to the skilled person, a reducing sugar is any sugar that is capable of acting as a reducing agent, because it has a free aldehyde group or a free ketone group. The one or more reducing sugars may for instance be selected from the group consisting of monosaccharides (e.g. glucose, fructose, allulose, or xylose), disaccharides (e.g. maltose, lactose, or cellobiose), DP3 saccharides (e.g. maltotriose) and DP4 saccharides (e.g. maltotetralose) and combinations thereof.

Preferably, the one or more reducing sugars include one or more monosaccharides. The one or more monosaccharides are preferably selected from the group consisting of glucose, fructose, allulose, xylose and combinations thereof.

The chocolate product according to the invention comprises one or more reducing sugars. Preferably, the ratio of the non-reducing sugar to the one or more reducing sugars in the chocolate product is between 95:5 and 50:50, preferably between 90:10 and 60:40, on a weight basis. Thus, as used herein, the weight of the one or more reducing sugars refers to the sum weight of the reducing sugars. As used herein the weight of the non-reducing sugar refers to the sum weight of the non-reducing sugars in the chocolate product. In an embodiment of the invention, the ratio of the non-reducing sugar to said one or more reducing sugars is equal to or below 67:33, preferably between 95:5 and 67:33, more preferably between 95:10 and 70:30, on a weight basis.

In a preferred embodiment, the one or more reducing sugars include one or more monosaccharides. Preferably, the ratio of the non-reducing sugar to said one or more monosaccharides in the chocolate product is between 95:5 and 50:50, preferably between 90:10 and 60:40, on a weight basis. Thus, as used herein, the weight of the one or more reducing sugars refers to the sum weight of the one or more monosaccharides. In an embodiment of the invention, the ratio of the non-reducing sugar to said one or more monosaccharides is equal to or below 67:33, preferably between 95:5 and 67:33, more preferably between 95:10 and 70:30, on a weight basis.

In a preferred embodiment, the one or more reducing sugars include glucose. Preferably, the ratio of the non-reducing sugar to glucose in the chocolate product is between 95:5 and 50:50, preferably between 90:10 and 60:40, on a weight basis. In an embodiment of the invention, the ratio of the non-reducing sugar to glucose is equal to or below 67:33, preferably between 95:5 and 67:33, more preferably between 95:10 and 70:30, on a weight basis.

Preferably, the non-reducing sugar is sucrose.

Preferably, the ratio of sucrose to the one or more reducing sugars in the chocolate product is between 95:5 and 50:50, preferably between 90:10 and 60:40, on a weight basis. Thus, as used herein, the weight of the one or more reducing sugars refers to the sum weight of the reducing sugars. In an embodiment of the invention, the ratio of sucrose to said one or more reducing sugars is equal to or below 67:33, preferably between 95:5 and 67:33, more preferably between 95:10 and 70:30, on a weight basis.

In a preferred embodiment, the one or more reducing sugars include one or more monosaccharides. Preferably, the ratio of sucrose to said one or more monosaccharides in the chocolate product is between 95:5 and 50:50, preferably between 90:10 and 60:40, on a weight basis. Thus, as used herein, the weight of the one or more reducing sugars refers to the sum weight of the one or more monosaccharides. In an embodiment of the invention, the ratio of sucrose to said one or more monosaccharides is equal to or below 67:33, preferably between 95:5 and 67:33, more preferably between 95:10 and 70:30, on a weight basis.

In a preferred embodiment, the one or more reducing sugars include glucose. Preferably, the ratio of sucrose to glucose in the chocolate product is between 95:5 and 50:50, preferably between 90:10 and 60:40, on a weight basis. In an embodiment of the invention, the ratio of sucrose to glucose is equal to or below 67:33, preferably between 95:5 and 67:33, more preferably between 95:10 and 70:30, on a weight basis.

The composition of the chocolate products according to the invention may vary between wide ranges.

Preferably, the chocolate products according to the invention comprise between 5 and 60 wt. %, preferably between 10 and 50 wt. %, more preferably between 20 and 40 wt. % of cocoa components with respect to the weight of the chocolate product. Most preferably, the chocolate product comprises at least 30 wt. % of cocoa components, or at least 35 wt. % of cocoa components with respect to the weight of the chocolate product. In a further preferred embodiment, the chocolate product comprises at least 38 wt. % of cocoa components or even et least 40 wt. % of cocoa component with respect to the weight of the chocolate product.

Preferably, the chocolate products according to the invention comprise between 5 and 40 wt. % of cocoa butter, preferably between 10 and 35 wt. % of cocoa butter, more preferably between 15 and 30 wt. % of cocoa butter with respect to the weight of the chocolate product.

The chocolate product may comprise any suitable amount of non-reducing sugar, for instance between 10 and 70 wt. % with respect to the weight of the chocolate product. Preferably, the chocolate products according to the invention comprise between 25 and 70 wt. % of non-reducing sugar, preferably between 35 and 65 wt. %, more preferably between 40 and 60 wt. % of non-reducing sugar with respect to the weight of the chocolate product. As used herein, the wt. % of non-reducing sugar refers to the sum weight of the non-reducing sugars present in the chocolate product.

The chocolate product may comprise any suitable amount of sucrose, for instance between 10 and 70 wt. % with respect to the weight of the chocolate product. Preferably, the chocolate products according to the invention comprise between 25 and 70 wt. % of sucrose, preferably between 35 and 65 wt. %, more preferably between 40 and 60 wt. % of sucrose with respect to the weight of the chocolate product.

Preferably, the cocoa components in the chocolate product include cocoa butter. It is also possible that the chocolate product comprises a chocolate compatible fat. As used herein, the term the chocolate compatible fat encompasses any of the vegetable or other fats suitable for use in combination with or in place of cocoa butter. Exemplary chocolate compatible fats include for instance palm oil, in particular fraction palm oil, palm kernel oil, illipe and shea nut butter, (fractionated and/or partially hydrogenated) soybean cotton or cottonseed oil, (fractionated and/or partially hydrogenated), coconut oil, lauric fat compounds. Said one or more other cocoa components preferably include cocoa butter and/or cocoa solids.

Preferably, the chocolate product according to the invention is obtainable by the method according to the invention.

The chocolate product according to the invention may be in any form. For instance, the chocolate product according to the invention may be a dough. Preferably, the chocolate product according to the invention is in the solid state.

Preferably, the chocolate product according to the invention is heat resistant. Preferably, the chocolate product according to the invention does not melt when kept in an oven at 40° C. for a period of 30 minutes. As discussed, the skilled person will understand this to mean that the chocolate product keeps its original shape when stored in an oven at 40° C. for a period of 30 minutes. More preferably, the chocolate product according to the invention does not melt when kept in an oven at 50° C., more preferably at 60° C., more preferably at 70° C. for a period of 30 minutes. Thus, the skilled person will understand this to mean that preferably the chocolate product keeps its original shape when stored in an oven at 50° C., more preferably at 60° C., more preferably at 70° C. for a period of 30 minutes.

Preferably, the chocolate product according to the invention comprises a sugar network. Without wishing to be bound any scientific theory it is believed that the development of heat resistance is associated with the development of such sugar network. The presence of a sugar network in heat resistant products has been described in Stortz, Terri & Marangoni, Alejandro. (2011). Heat resistant chocolate. Trends in Food Science & Technology—TRENDS FOOD SCI TECHNOL. 22. 201-214. 10.1016/j.tifs.2011.02.001. The presence of a sugar network can be detected by autofluorescence measurement using a confocal laser scanning microscope and using excitation by a UV range laser (405 nm) and detection of emitted signals between 415-500 nm. A description of autofluorescence measurement of sugar is provided in Baunsgaard, Dorrit & Munck, L. & Norgaard, Lars. (2000). Analysis of the Effect of Crystal Size and Color Distribution on Fluorescence Measurements of Solid Sugar Using Chemometrics. Applied Spectroscopy—APPL SPECTROSC. 54. 1684-1689. 10.1366/0003702001948727.

In a preferred embodiment, the chocolate product according to the invention comprises type V crystals.

In a preferred embodiment, the fats in the chocolate product are solid at 20° C.

In a preferred embodiment, the chocolate product according to the invention does not comprise any polyol.

In an embodiment of the invention, the chocolate product according to the invention does not comprise any artificial sweetener or high intensity sweetener. In a preferred embodiment, the chocolate product according to the invention is covered with a layer comprising shellac, bee wax, and/or carnauba wax. This provides the chocolate with a shiny appearance.

### Food Products and Uses—Preparation of Food Products

The chocolate products according to the invention have good processability and are very suitable for the use in food products. They are particularly suitable to cover and/or enrobe food products.

Accordingly, the invention also provides a food product comprising a chocolate product according to the invention. Preferably, the food product is a bakery product (for instance a biscuit or a cake), a dairy product (for instance a milk or yoghurt containing the chocolate product according to the invention), a moulded product, and/or a confectionery product, such as for instance a candy bar.

The invention further provides a food product, which comprises an edible substrate and the chocolate product, wherein the chocolate product is disposed on the edible substrate; and/or wherein the chocolate product at least partly enrobes the edible substrate.

The invention further provides the use of the chocolate product according to the invention for the preparation of a food product, for instance, bakery product, a dairy product; and/or a confectionery product, for instance a candy bar or a praline.

In a preferred embodiment, the food product is a frozen product, for instance an ice cream.

The invention further provides a method for preparing a food product, said method comprising preparing a chocolate product using the method according to the invention, providing a chocolate product obtainable by the method according to the invention; and/or providing a chocolate product according to the invention; and using the chocolate product to prepare the food product.

In a preferred embodiment, the food product is a moulded chocolate product and the method comprises feeding the chocolate product (for instance the mixture resulting from (b)) to a mould, optionally followed by aging the product to obtain a heat resistant chocolate product.

In another preferred embodiment, the food product comprises an edible substrate, and the method comprises applying the chocolate product (for instance the mixture resulting from (b)) on the edible substrate, optionally followed by aging the chocolate product to obtain a heat resistant chocolate product.

In another preferred embodiment, the method comprises incorporating the chocolate product into the food product.

The invention will now be illustrated with reference to the following examples, without being limited thereto.

### EXAMPLES

### Examples—Basic Exemplary Procedure

The following basic procedure was applied in the examples. The exact amounts of ingredients have been indicated in the tables. Deviations from the basic procedures have been indicated as well.

Measurement of the temperature was performed using a candy thermometer (CDN®).

First, water, sugar (sucrose) and glucose, were mixed and heated under agitation to a temperature of approximately 70-80° C. Furthermore, in most instances, a few grams of trisuc (Liquid trisuc 73% provided by Belgosuc, a partly inverted sugar syrup obtained through acid hydrolysis of an aqueous solution of sucrose) and sucrose ester (SP-70 from Sisterna®) were added in the beginning of the processes in order to make the entire mixture easier to process.

As soon as the mixture had attained a temperature of approximately 70-80° C., cocoa mass (this is a thick paste of finely ground cocoa beans and consists entirely or essentially of cocoa butter and cocoa powder) and, if applicable other cocoa components, were added and the mixture comprising cocoa was heated further under agitation to a temperature varying between 100-115° C. (depending on the recipe—see tables). In order to prevent burning of the mixture comprising cocoa, the heating to 100-115° C. took place in an open copper kettle.

During the heating, the cocoa butter was found to separate from the cocoa liquor and to float on the mixture. The temperature at which this takes place is dependent on the amount of cocoa butter. This temperature was usually above 100° C. Upon the observation of the separation of cocoa butter and floating thereof, most of the water had evaporated, and the heat source was turned off. During the subsequent cooling down to a temperature of about 80° C., the mixture was agitated such as to mix and to obtain a homogeneous mixture.

Subsequently, the chocolate product was forcibly cooled down to approximately by pouring the chocolate product onto a worktop, in most cases to a temperature of between 40 and 45° C.

In order to improve the taste of the chocolate product, the chocolate product was stirred in a mechanical mixer for approximately 3 minutes. At that time often a structure with strings was observed. The temperature was then between 30 and 40° C.

Then, the chocolate product was, using a piping bag, used to fill moulds to make chocolate, to cover biscuits, candy bars, coconut mass, and to form a layer between biscuits. Sometimes a heating lamp was used (to avoid a temperature decrease) to extend the time during which the processability of the chocolate remained optimal. The resulting products were then maintained at room temperature for a period varying between a few hours and approximately two days in order to give it enough time to develop heat resistance.

### Heat Resistance Test

Heat resistance was tested by putting the chocolate product in an oven at 40° C. and keeping it at this temperature for 30 minutes—The temperature was then increased in steps of 5° C., with a period of 30 minutes between each step. The temperature at which melting was observed was reported.

### Ether Test

A glass (approximately 5 cl) was filled with ether in which the chocolate was immersed at room temperature.

In case of convention chocolate (milk chocolate of Côte d'Or) the onset of dissolution of fat was observed after 30 seconds. After 50 minutes, the conventional chocolate was found to be completely disintegrated/dissociated. This supports that cocoa butter, which is soluble in ether, forms the matrix of conventional chocolate.

Chocolates according to the present invention remained were still completely intact after 50 minutes. This confirms that cocoa butter is prevented from dissolving in ether, presumably since it is entrapped in a sugar and water structure.

### Measurement of Water Content in the (Solid) Chocolate Product

Water content in the chocolate product was measured using a PRECISA EM(XM) 120 moisture analyser. The chocolate product was ground and a sample size of 5 g was used. Measurements were performed in triplicate and the average was taken.

### Example 1

Chocolate products were prepared based on the recipes indicated in table 1:

TABLE 1

| | Example 1-1 | Example 1-2 |
|---|---|---|
| water (g) | 550 | 550 |
| sugar (sucrose) (g) | 640 | 640 |
| glucose (g) | 0 | 0 |
| sucrose ester (g) | 2.9 | 2.9 |
| trisuc (g) | 2.5 | 2.5 |
| cocoamass* (g) | 362 | 362 |
| aroma/vanilla (g) | | 1.2 |
| sum ingredients prior to | 1557.4 | 1558.6 |
| heating (g) | | |
| Boiling temperature (° C.) | 106 | 106 |

*CM-CAL-552 from Callebaut ®

The products can withstand a temperature of 75° C. and do not dissolve in ether.

### Example 2

Chocolate products were prepared using glucose in addition to the other ingredients. Pure chocolate as well as milk chocolate (example 2-4) were prepared. The recipes have been indicated in Table 2.

It was found that the use of glucose substantially improved the processability of the chocolate, as well as the texture and taste of the product

The products can withstand a temperature of 75° C. and do not dissolve in ether.

TABLE 2

| | Example | Example | Example | Example |
|---|---|---|---|---|
| | 2-1 | 2-4 | 2-3 | 2-4 |
| water (g) | 550 | 550 | 550 | 550 |
| sugar (sucrose) (g) | 550 | 550 | 550 | 550 |
| glucose (g) | 90 | 90 | 90 | 90 |
| sucrose ester (g) | 2.9 | 0 | 2.9 | 2.9 |
| trisuc (g) | 2.5 | 2.5 | 0 | 2.5 |
| cocoamass* (g) | 362 | 362 | 362 | 180 |
| milk powder (g) | | | | 180 |
| aroma/vanilla (g) | 1.2 | | | |
| sum ingredients | 1558.6 | 1554.5 | 1554.9 | 1555.4 |
| prior to heating (g) | | | | |
| Boiling temperature | 106° C. | 106° C. | 106° C. | 102° C. |

*CM-CAL-552 from Callebaut ®

### Example 3

Chocolate products were prepared with the amount of glucose used being varied. The recipes have been indicated in Table 3.

TABLE 3

| | Example 3-1 | Example 3-2 | Example 3-3 |
|---|---|---|---|
| water (g) | 550 | 550 | 550 |
| sugar (sucrose) (g) | 580 | 550 | 460 |
| glucose (g) | 60 | 90 | 180 |
| sucrose ester (g) | 2.9 | 2.9 | 2.9 |
| trisuc (g) | 2.5 | 2.5 | 2.5 |
| cocoamass* (g) | 362 | 362 | 362 |
| aroma/vanilla (g) | 1.2 | 1.2 | |
| sum ingredients | 1558.6 | 1558.6 | 1557.4 |
| prior to heating (g) | | | |
| Boiling temperature | 106° C. | 106° C. | 106° C. |

*CM-CAL-552 from Callebaut ®

The products can withstand a temperature of 75° C. and do not dissolve in ether.

### Example 4

Chocolate products were prepared with the amount of water used being varied. The recipes have been indicated in Table 4.

An electric stainless steel vessel was used instead of a copper pot. Table 4 indicates the sum of the warming up time and heating time, as well as the weight of the mixture prior to heating and the weight of the mixture after having been poured on the work top. This enabled to calculate the amount of water remaining after heating in examples 4-1 and 4-3. It was found that about 10 wt. % of water remained in the mixture after heating.

Further, it was observed that the product made using the highest amount of water (500 g) has a more intense taste. It is hypothesized that this is due to the longer heating time which enables Maillard reactions to proceed for a longer time.

The products can withstand a temperature of 75° C. and do not dissolve in ether.

TABLE 4

| | Example 4-1 | Example 4-2 | Example 4-3 |
|---|---|---|---|
| water (g) | 150 | 200 | 500 |
| sugar (sucrose) (g) | 550 | 550 | 550 |
| glucose (g) | 90 | 90 | 90 |
| sucrose ester (g) | 2.9 | 2.9 | 2.9 |
| trisuc (g) | 2.5 | 2.5 | 2.5 |
| cocoamass* (g) | 362 | 362 | 362 |
| sum ingredients prior to | 1157.4 | 1207.4 | 1507.4 |
| heating (g) | | | |
| sum ingredients after | 1114 | | 1123 |
| heating (g) | | | |
| Water remaining in mixture | 106.6 (9.6%) | | 116.4 (10.4%) |
| after, calculated (g) | | | |
| Heating time + warming up | 7 | 20 | 35 |
| time (min) | | | |
| Boiling temperature | 106° C. | 110° C. | 106° C. |

*CM-CAL-552 from Callebaut ®

### Example 5

Couvertures were prepared using the recipes as indicated in Table 5.

The resistance against heat has been indicated in Table 5 as well. The products do not dissolve in ether.

TABLE 5

| | Example | Example | Example | Example |
|---|---|---|---|---|
| | 5-1 | 5-2 | 5-3 | 5-4 |
| | (milk) | (pure) | (pure) | (white) |
| water (g) | 550 | 550 | 550 | 550 |
| sugar (sucrose) (g) | 50 | 0 | 120 | 0 |
| glucose (g) | 90 | 90 | 90 | 90 |
| sucrose ester (g) | 2.9 | 2.9 | 2.9 | 2.9 |
| trisuc (g) | 2.5 | 2.5 | 2.5 | 2.5 |
| 823-E1- | 912 | | | |
| U68/callebaut*) | | | | |
| 811-E1- | | 912 | 912 | |
| U6/Callebaut**) | | | | |
| W2-E1- | | | | 912 |
| U68/Callebaut**) | | | | |
| sum ingredients | 1607.4 | 1557.4 | 1677.4 | 1557.4 |
| prior to heating (g) | | | | |
| Boiling temperature | 111° C. | 107° C. | 107° C. | 104° C. |
| Heat resistency | 75° C. | 65° C. | 75° C. | 60° C. |
| (max temperature) | | | | |

*)42.0% sugar (sucrose), 24.0% cocoa butter, 22.5% milk powder (whole milk), 11.0% cacao mass,
**)43.0% sugar (sucrose), 43.0% cocoa mass, 13.0% cocoa butter
***) 46.5% sugar (sucrose), 29.5% cocoa butter, 23.5% milk powder (whole milk)

### Example 6

Further, chocolate products were prepared using the recipes indicated in Table 6.

The products can withstand a temperature of 75° C. and do not dissolve in ether.

Example 6-2 was performed twice, once in accordance with the standard basic procedure, and once wherein the mixture was entirely cooled in the pot instead of by pouring the product on the worktop. In both cases a heat resistant product was obtained.

TABLE 6

| | Example | Example | Example | Example |
|---|---|---|---|---|
| | 6-1 | 6-2 | 6-3 | 6-4 |
| water (g) | 220 | 550 | 550 | 550 |
| sugar (sucrose) (g) | 940 | 565 | 565 | 550 |
| glucose (g) | 280 | 75 | 75 | 90 |
| sucrose ester (g) | 1.3 | 2.9 | 2.9 | 2.9 |
| trisuc (g) | 2.3 | 2.5 | 2.5 | 2.5 |
| cocoamass* (g) | 120 | 362 | 362 | |
| lecithine | | 1.75 | 2 | |
| Cocoa powder | | | | 167 |
| Cocoa butter | | | | 195 |
| Cocoa paste** | 110 | | | |
| aroma/vanilla | 1.2 | | | |
| sum ingredients | 1674.8 | 1560.35 | 1560.6 | 1557.4 |
| prior to heating (g) | | | | |
| Boiling temperature | 124° C. | 104° C. | 104° C. | 108° C. |

*CM-CAL-552 from Callebaut ®
**60% water, 40% Cocoa powder (100014-793 from Callebaut ®)

### Example 7

138 g water, 138 g sucrose, 22 g glucose, 0.75 trisuc were mixed and heated to 80° C. At 80° C., 90 g cocoa mass was added (total mass ingredients was 388.75 g.). Heating was continued while stirring, resulting in evaporation of water (temperature 98-104° C.). The weight of the liquid mass was monitored. Evaporation was continued until a specific remaining water content (calculated based on weight difference due to evaporation of water) was achieved as indicated in table 7. Then, the liquid mass was cooled using a cold, hard, surface until a temperature of between 75-65° C., after which the mass was transferred into a vessel in which it was mixed for 2 minutes using a mixer. During the mixing the color of the mass was found to become lighter and strings were observed which indicated that it had become optimal for further processing. Upon completion of the mixing the temperature was between 50-35° C.

After mixing, the mixture was transferred to a piping bag to fill hard plastic moulds (about 10 g of mixture per mould). The filled moulds were cooled in a freezer at a temperature of −15° C. (10-60 minutes), after which the resulting chocolate products were released from the mould. This cooling step was performed to facilitate the release of the chocolate products from the moulds. The chocolate products were then kept at room temperature (20° C.) to enable aging. The aging was continued until a hard chocolate product was obtained. The time needed to obtain a hard chocolate product varied between a few hours and a few days depending on the remaining water content in the mass (indicated in table 7). after mixing prior to filling.

The water content of the resulting (aged) products were analysed using a PRECISA EM(XM) 120 moisture analyser as described above. The results have been shown in table 7.

Heat resistancy of the resulting (aged) products was confirmed using the heat resistance test described above. The results have been shown in table 7. All products were heat resistant.

TABLE 7

| | Ex. 7-1 | Ex. 7-2 | Ex 7-3 | Ex. 7-4 |
|---|---|---|---|---|
| water content in | 9 | 11.5 | 13 | 15 |
| mixture after | | | | |
| evaporation (wt. %) *) | | | | |
| water content in | 7.7 | 8.8 | 6.9 | 8.1 |
| heat resistant | | | | |
| chocolate (wt. %) | | | | |
| Heat resistance | 55° C.+ | 55° C.+ | 55° C.+ | 55° C.+ |

*) calculated based on weight difference due to evaporation of water

### Example 8

Example 7 was repeated with the difference that evaporation was continued to obtain levels of water in the mixture (calculated based on weight difference due to evaporation of water) as indicated in table 8 and that—after cooling of the liquid mass using the cold, hard surface—25 g of cocoa mass and 15 g cocoa butter were added, prior to the mixing step. The results have been shown in table 8. All chocolate products obtained were heat resistant.

TABLE 8

| | Ex 8-1 | Ex. 8-2 | Ex. 8-3 |
|---|---|---|---|
| water content in mixture | 13 | 15 | 18 |
| after evaporation (wt. %)*) | | | |
| Water content in mixture | 11.4 | 13.2 | 15.0 |
| after addition of additional | | | |
| cocoa mass and cocoa | | | |
| butter (wt. %)**) | | | |
| water content in heat | 8.8 | 8.6 | 8.0 |
| resistant chocolate (wt. %) | | | |
| Heat resistance | 55° C. | 55° C. | 45° C. |

*)calculated based on weight difference due to evaporation of water
**)based on calculation

### Example 9

Example 7 was repeated with the difference that 115 g sucrose (instead of 138 g) and 45 g glucose (instead of 22 g) were used. The results have been shown in table 9. All chocolate products were heat resistant.

TABLE 9

| | Ex. 9-1 | Ex. 9-2 | Ex 9-3 |
|---|---|---|---|
| water content in mixture | 7 | 9 | 11.5 |
| after evaporation (wt. %) *) | | | |
| water content in heat | 9.4 | 8.2 | 6.0 |
| resistant chocolate (wt. %) | | | |
| Heat resistance (wt. %) | 45° C. | 45° C. | 50° C. |

*) calculated based on weight difference due to evaporation of water

### Example 10

Example 9 was repeated with the difference that evaporation was continued to obtain levels of water in the mixture as indicated in table 10 and that—after cooling of the liquid mass using the cold, hard surface—25 g of cocoa mass and 15 g cocoa butter were added prior to the mixing step. The results have been shown in table 10. All chocolate products obtained were heat resistant.

TABLE 10

| | Ex | Ex. | Ex. | Ex | Ex. | Ex. |
|---|---|---|---|---|---|---|
| | 10-1 | 10-2 | 10-3 | 10-4 | 10-5 | 10-6 |
| water content in mixture | 7 | 9 | 11.5 | 13 | 15 | 18 |
| after evaporation (wt. %) *) | | | | | | |
| Water content in mixture | 6.1 | 7.9 | 10.1 | 11.4 | 13.2 | 15.1 |
| after addition of additional | | | | | | |
| cocoa mass and cocoa | | | | | | |
| butter (wt. %) **) | | | | | | |
| water content in heat | 7.1 | 7.3 | 8.3 | 8.4 | 5.1 | 7.2 |
| resistant chocolate (wt. %) | | | | | | |
| Heat resistance | 50° | 55° | 55° | 55° | 40° | 55° |
| | C. | C. | C. | C. | C. | C.+ |

*) calculated based on weight difference due to evaporation of water
** ) based on calculation

### Example 11

Example 8 was repeated with the difference the following ingredients were used: 138 g water, 138 g sucrose, 22 g glucose, 1.1 g trisuc, and 90 g cocoa mass (from Cargill (WAF02)). An additional 20 g cocoa butter and an additional 40 g of cocoa mass (from Cargill (WAF02)) was added in the mixing stage. The results have been indicated in Table 11. Heat resistant chocolate was obtained.

TABLE 11

| | Ex 11 |
|---|---|
| water content in mixture after evaporation (wt. %) *) | 10.31 |
| Water content in mixture after addition of additional | 7.74 |
| cocoa mass and cocoa butter (wt. %) **) | |
| water content in heat resistant chocolate (wt. %) | 8.17 |

*) calculated based on weight difference due to evaporation of water
**) based on calculation

### Further Observations Regarding the Exemplified Products

In addition to the good heat resistance shown above, the exemplified products according to the invention were found to have the following characteristics:
intense taste experience
the product is not sticky
good bite
enables good moulding and covering
brownie effect: when heated in the range from 65 to 120° C., the taste of a brownie is experienced
no fat blooming observed
no sugar blooming observed
after aging, the bite is so close to usual (non heat resistant) chocolate that it is hard to notice a difference.
no change of taste and smell when stored near products having a strong smell (it is a known phenomenon that chocolate can—when stored near products having a strong smell—easily take over such smell).

1-121. (canceled)

122. A method for preparing a chocolate product, the process comprising:
(a) providing a mixture, said mixture comprising:
(i) one or more cocoa components;
(ii) a non-reducing sugar;
(iii) one or more reducing sugars; and
(iv) water;
(b) mechanically agitating the mixture at a temperature at which the mixture is in a liquid state and/or at a temperature of at least 40° C.; and

123. The method according to claim 122, wherein said providing the mixture comprises:
(I) preparing a pre-mixture, said pre-mixture comprising at least part of said one or more cocoa components, at least part of said non-reducing sugar, at least part of said one or more reducing sugars, and water; and
(II) heating the pre-mixture at a temperature of at least 90° C. and/or heating said pre-mixture at a temperature sufficiently high to effect evaporation of at least part of the water in the pre-mixture.

124. The method according to claim 123, wherein the method further comprises (c) aging the mixture resulting from (b) at a temperature below 40° C.

125. The method according to claim 122, wherein the mixture comprises between 5 and 80 wt. % of cocoa components with respect to the weight of the mixture, excluding water.

126. The method according to claim 122, wherein the mixture comprises cocoa butter, milk fat and/or chocolate compatible fat.

127. The method according to claim 122, wherein said one or more cocoa components comprises between 5 and 60 wt. % of cocoa butter with respect to the weight of the mixture, excluding water.

128. The method according to claim 122, wherein the mixture comprises between 10 and 70 wt. % of said non-reducing sugar, with respect to the weight of the mixture, excluding water and wherein the ratio of sucrose to said one or more reducing sugars is between 95:5 and 50:50.

129. The method according to claim 122, wherein the method comprises providing at least part of the cocoa components by admixing cocoa liquor, cocoa mass and/or conched chocolate to obtain the mixture.

130. The method according to claim 122, wherein said one or more reducing sugars comprises one or more monosaccharides.

131. The method according to claim 130, wherein said one or more monosaccharides comprises glucose.

132. The method according to claim 122, wherein said non-reducing sugar comprises sucrose.

133. The method according to claim 122, wherein the mixture comprises less than 25 wt. % of water with respect to the weight of the mixture.

134. The method according to claim 123, wherein the method further comprises (III) cooling the mixture resulting from (II) in a vessel, in a cooling tunnel and/or with a cooling surface.

135. The method according to claim 134, wherein the method further comprises, after (II) or after (III), adding further cocoa components to the pre-mixture.

136. The method according to claim 122, wherein said aging results in a heat resistant chocolate product, wherein the heat resistant chocolate product does not melt when kept in an oven at 40° C. for a period of at least 30 minutes.

137. The method according to claim 122, wherein the chocolate product is mouldable.

138. A chocolate product comprising:
(I) one or more cocoa components;
(II) a non-reducing sugar;
(III) one or more reducing sugars; and
(IV) water
wherein said chocolate product comprises between 4 and 20 wt. % of water with respect to the weight of the chocolate product.

139. The chocolate product according to claim 138, wherein said one or more cocoa components comprises between 5 and 60 wt. % of cocoa butter with respect to the weight of the chocolate product and wherein said chocolate product comprises between 5 and 80 wt. % of cocoa components with respect to the weight of the chocolate product.

140. The chocolate product according to claim 138, wherein said one or more reducing sugars include one or more monosaccharides.

141. The chocolate product according to claim 138, wherein said one or more reducing sugars comprises glucose.

142. The chocolate product according to claim 138, wherein said non-reducing sugar comprises sucrose and wherein the ratio of sucrose to said one or more reducing sugars is between 95:5 and 50:50.

143. The chocolate product according to claim 138, wherein said chocolate product is heat resistant.

144. The chocolate product according to claim 138, wherein said chocolate product is mouldable.

145. A food product comprising a chocolate product, wherein the chocolate product comprises
(I) one or more cocoa components;
(II) a non-reducing sugar;
(III) one or more reducing sugars; and
(IV) water
wherein said chocolate product comprises between 4 and 20 wt. % of water with respect to the weight of the chocolate product.
